(19) United States
(12) Patent Application Publication
(10) Pub. No.: US 2014/0214181 A1
(43) Pub. Date: Jul. 31, 2014

(54) CONTROL SYSTEM FOR SOFTWARE TERMINATION PROTECTION

(71) Applicant: CATERPILLAR INC., Peoria, IL (US)

(72) Inventors: Behrouz Ghazanfari, Plainfield, IL (US); Dennis John Melas, Chicago, IL (US); Gregory Raymond Kupiec, Lemont, IL (US)

(73) Assignee: Caterpillar Inc., Peoria, IL (US)

(21) Appl. No.: 13/753,878

(22) Filed: Jan. 30, 2013

(51) Int. Cl. G05B 19/02

(52) U.S. Cl. CPC G05B 19/02
USPC 700/23

(57) ABSTRACT

The present disclosure is directed to a control system for a machine. The control system has an electronic module that includes a memory storing a control system software. The control system also includes at least one programmable controller in communication with the memory, where the at least one programmable controller is configured to protect machine components from damage by running the control system software, detecting a control system software fault, intercepting a process fault termination command, setting at least one output signal in response to the control system software fault, terminating at least part of the control system software that contains the control system software fault, and resetting at least part of the control system.

### TECHNICAL FIELD

The present disclosure relates generally to a control system, and more particularly, to a machine control system for software termination protection.

### BACKGROUND

Machines such as traditional locomotives are known to use a centralized on-board computer-based control system. Typically, conventional control systems for these types of machines may include a central processing unit on an electronic module. When control system software causes the electronic module to perform illegal operations (for example, if the central processing unit attempts to write to a “read only” memory location), a modern operating system may detect the illegal operation and terminate the control system software application process that has directed the central processing unit to perform the operation. The automatic termination of some software application processes may cause the control system to enter into a failure condition.

Some machines contain a “watchdog” circuit that monitors the control system for a failure condition that may cause damage to the system components. Depending on the architecture of the control system and machine, the watchdog circuit may reset the electronic module by powering it off, then on again, when the watchdog circuit detects a failure condition. Resetting the module resets the control system software and may take many seconds to complete the reset cycle. In some instances, the control system may be in a state during the reset period that could cause damage to the equipment that it is controlling. For example, if the machine is a locomotive that is in operation while an application process is terminated, system equipment could be damaged from residual voltage in the system components during the reset cycle. There are many possible causes of system damage during this restart period.

Currently, if a control system fault condition is detected by an operating system running on the machine, some auxiliary systems of the machine may be configured to detect when their connections to the control system are lost due to the fault condition. The lost connection may cause the auxiliary systems on-board the machine to trip their respective protective devices as a measure to control damage to their hardware. An example of an auxiliary system may be the power generation system on-board a machine. Current control systems may deploy automatic safety and/or recovery measures, such as resetting the control subsystem that has experienced the fault, and/or automatically deploying a hardware protective device. An example of a protective device is a silicone switch called a “crowbar” that physically crosses a DC BUS associated with a main power generator on-board the machine in order to quickly drop the DC voltage before damage to the connected components occurs. Generally, a crowbar is designed to drop the voltage across any capacitors that are on the DC BUS. The main generator may be disconnected from the faulting components when the operating system detects a software termination in “failure mode.” However, in some circumstances, the main power generator may continue generating high voltages. Such crowbars are not generally designed to sustain high voltages produced by the machine generators for a prolonged period, and may not block very high voltage across the auxiliary systems in these circumstances. Consequently, even when a crowbar is employed by known control systems, safety devices and auxiliary system components may be damaged by the high residual voltages during the automatic reset.

One exemplary method used to resolve a fault in a machine control system is described in U.S. Pat. No. 7,133,756 (the '756 patent). The '756 patent describes a system that is configured for autonomously resolving control system failures. The '756 patent presents several techniques and systems for autonomously correcting or recovering from control system faults in a locomotive. For example, the '756 patent describes a self-healing technique that detects a control system fault. In response to such detection, the control system resets the subsystem with the fault by power-cycling the subsystem or component. However, the'756 patent is silent as to systematic shut-down features that mitigate or prevent system damage that may occur during the shut-down process.

The presently disclosed control system is directed to overcoming one or more of the problems set forth above and/or other problems in the art.

### SUMMARY OF THE INVENTION

In accordance with one aspect, the present disclosure is directed to a control system that includes an electronic module having a memory storing control system software. The control system includes at least one programmable controller in communication with the memory, where the at least one programmable controller is configured to detect a control system software fault, intercept a process fault termination command sent by an operating system in response to the detected control system software fault, set at least one output signal in response to detecting the control system software fault, terminate at least one active control system software process associated with the control system software fault, and reset at least part of the control system.

According to another aspect, the present disclosure is directed to a method for protecting machine components from damage caused by a control system software fault. The method may include executing a control system software stored on an electronic module, detecting a control system software fault, setting at least one output signal in response to the control system software fault, terminating at least one active control system software process associated with the control system software fault, and resetting at least part of the control system.

### BRIEF DESCRIPTION OF THE DRAWINGS

FIG. 1 illustrates a pictorial view of an exemplary disclosed machine;

FIG. 2 is a diagrammatic illustration of an exemplary control system that may be used in conjunction with the machine of FIG. 1;

FIG. 3 is a diagrammatic illustration of an exemplary electronic module that may be used in conjunction with the control system of FIG. 2; and

FIG. 4 provides a flowchart depicting an exemplary method for software termination protection according to an embodiment of the present disclosure.

### DETAILED DESCRIPTION

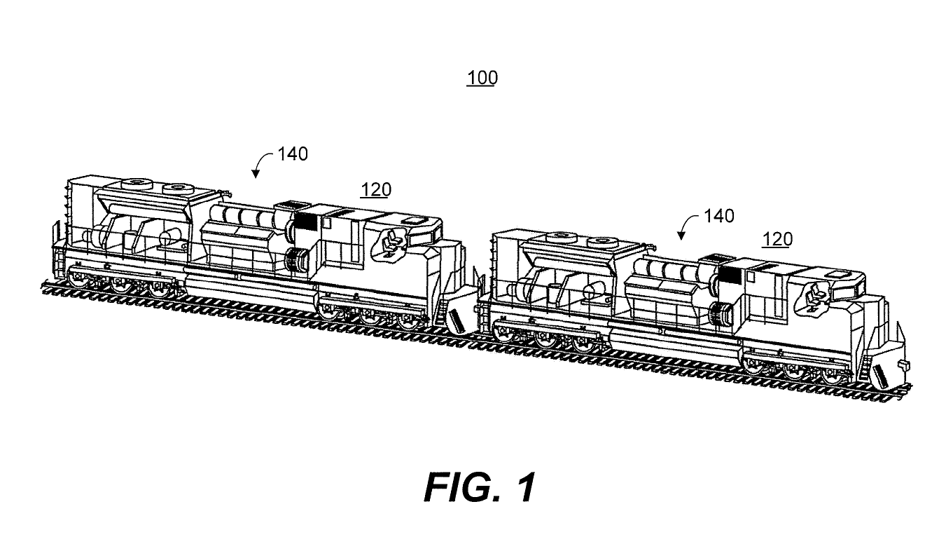

FIG. 1 illustrates an exemplary machine 100. Machine 100 may embody an autonomous, semi-autonomous or manually controlled machine. For example, machine 100 may be a plurality of locomotives 120 (shown in FIG. 1), a wheel loader, a motor grader, or any other mobile machine known in the art. Machine 100 may alternatively embody another type of machine, such as an on-road vehicle, an off-road vehicle, a passenger vehicle, a stationary generator set, a pumping mechanism, or any other suitable operation-performing machine.

Each locomotive 120 of machine 100 may include a locomotive engine 140. In one embodiment, locomotive engine 140 may comprise a uniflow two-stroke diesel engine system. Those skilled in the art will also appreciate that each locomotive 120 may also, for example, include an operator cab (not shown), facilities used to house electronics, such as electronics lockers (not shown), protective housings for locomotive engine 140 (not shown), and a generator used in conjunction with locomotive engine 140 (not shown). While not shown in FIG. 1, machine 100 may comprise more than two locomotives 120. Additionally, machine 100 may also comprise a variety of other railroad cars, such as freight cars or passenger cars, and may employ different arrangements of the cars and locomotives to suit the particular use of machine 100. Machine 100 may include various machine components. For example, machine components may include any one or more of the electrical and/or mechanical elements of the machine that are employed in the operation of machine 100, including but not limited to control elements, electronic modules, sensors, power generation equipment, power distribution equipment, protection equipment, etc.

In an embodiment, the locomotives 120 of machine 100 communicate with each other through, for example, wired or wireless connections between the locomotives 120. Particular examples of such connections may include, but are not limited to, a wired Ethernet network connection, a wireless network connection, a wireless radio connection, a wired serial or parallel data communication connection, or other such general communication pathway that operatively links control and communication systems on-board machine 100.

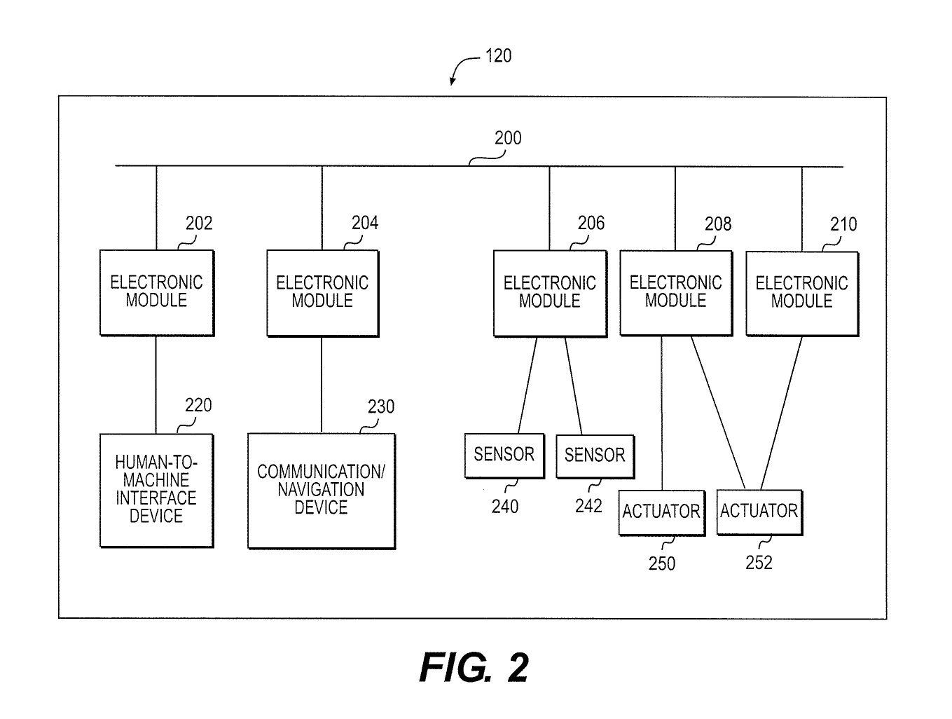

FIG. 2 illustrates elements of an exemplary control system disposed within locomotive 120 of machine 100 for controlling locomotive 120. For example, the control system may control the motion of locomotive 120 by controlling traction power of locomotive engine 140 and/or dynamic braking of locomotive 120. As shown in FIG. 2, an exemplary control system may comprise a network 200. Network 200 may include one or more different data communication paths over which data having different communication formats may be transmitted. For example, network 200 may be used to transmit Ethernet TCP/IP based data, RS 232 data, RS422 data, controller area network (CAN) bus data, or a combination of two or more of these data types. In exemplary embodiments, different types of data may use differing parts of network 200. For example, Ethernet data may use a physically separate data communication path of network 200 than CAN bus data. Alternatively, there may be priorities assigned to particular types of data. For example, in one embodiment, messages associated with CAN bus data may be assigned a higher priority than other types of messaging traffic on network 200.

As part of implementing control functions used to control the locomotive, the embodiment illustrated in FIG. 2 includes a plurality of electronic modules 202-210 communicatively coupled to network 200 in a standardized architecture. In other words, electronic modules 202-210 are based on standardized hardware (e.g., similar components, similar boards, etc.), and software that can be flexibly configured and programmed in an architecture that allows for additions depending on the needs of the control system. For example, in one embodiment, a single electronic module 202 may implement a particular control function. But if this control function is deemed or becomes a mission critical control function, an alternative embodiment may implement such a mission critical control function with several electronic modules. Examples of control functions may include, throttle control of the locomotive engine, dynamic braking, etc. In another example, each electronic module 202-210 may host control applications (e.g., software applications) that consume a certain percentage of its processing capacity. Each of the control applications may include written instructions for software processes that perform, at least in part, various control functions when executed.

Electronic modules 202-210 may be programmed and configured to communicatively connect to one or more control elements disposed within the locomotive 120. As shown in FIG. 2, exemplary control elements may include a human-to-machine interface device 220. Human-to-machine interface device 220 may be a device that provides feedback to and/or input from a human, such as the operator of the locomotive 120. Human-to-machine interface device 220 may include, for example, one or more of a monitor, a light emitting diode, an indicator, a switch, a button, a keypad, a keyboard, a touchpad, a joystick, a speaker, a microphone, and a credential reader such as finger print scanner or an ID card scanner. Control elements may also be, for example, devices not shown but are used in conjunction with a locomotive, including a generator field contactor feedback, a generator field decay contactor feedback, an inverter, a protection circuit, a traction inverter, a field supply chopper traction alternator control device, a main generator, an auxiliary generator, and/or any machine component previously described.

Another example of a control element is a communication/navigation device 230, which may be a device that provides communication within or outside the locomotive 120 or receives/transmits navigational information within or outside the locomotive 120. An example of communication/navigation device 230 may include, for example, one or more of an analog radio, a digital communication receiver/transmitter, a GPS unit, and a tracking transponder.

Sensors 240 and 242 and actuators 250 and 252 are additional examples of control elements operatively connected to one or more electronic modules 206, 208, and 210. Sensors 240, 242 may be any type of device that records or senses a condition or characteristic relative to the locomotive, such as speed, temperature, atmospheric conditions, shock, vibration, frequency, engine conditions, etc. Various voltages (e.g., DC link voltage) and amperages (e.g., blower motor or traction motor amperage) may be used to represent the sensed conditions or characteristics. Similarly, actuators 250, 252 may be any type of device that changes a condition or characteristic relative to the locomotive, such as a throttle, brake, heater, fuel flow regulator, generator, damper, pump, switch, relay, solenoid, etc. In one embodiment, actuators 250, 252 may assist in controlling a mechanical or electrical device.

In an embodiment, a single electronic module may be connected to one or more control elements. For example, as shown in FIG. 2, electronic module 206 may be connected to both of sensors 240 and 242. Alternatively, in one embodiment, electronic module 206 may be connected to sensors 240 and 242, and actuators 250 and 252. The configuration of how many electronic modules may be used with particular control elements will depend on the desired application within a locomotive 120 or other machine 100.

While FIG. 2 shows an exemplary embodiment of a control system with control elements that include sensors 240, 242, actuators 250, 252, a communication device and/or navigation device 230, and a human-to-machine interface device 220, those skilled in the art will appreciate that additional exemplary embodiments may include other control elements useful in monitoring and controlling aspects of locomotive operation.

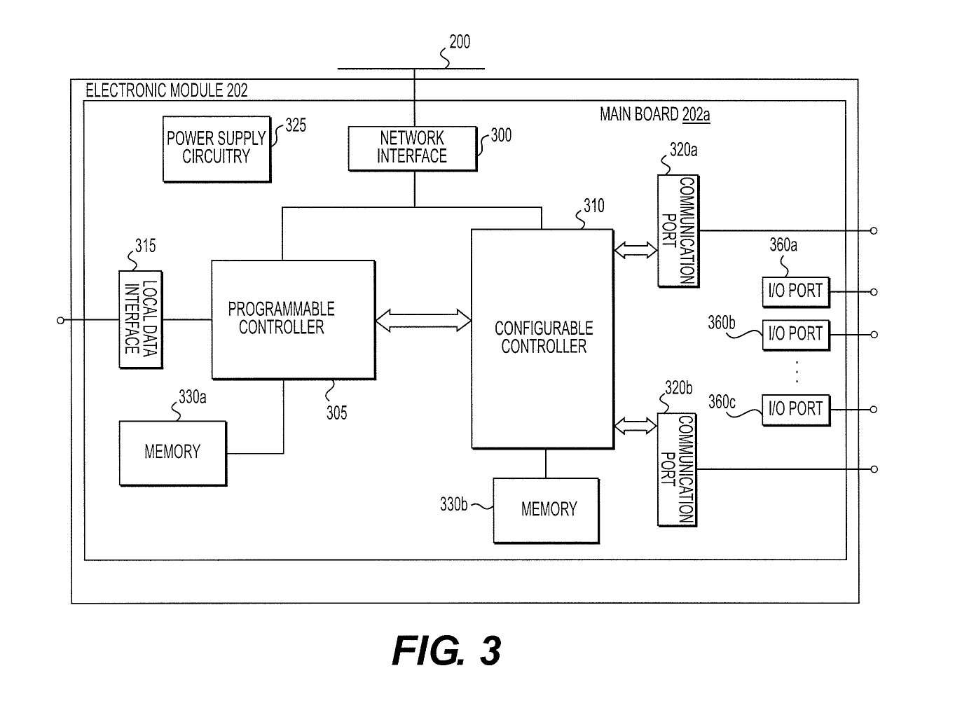

FIG. 3 provides a block diagram of an exemplary electronic module 202 within the exemplary control system of FIG. 2. As shown in FIG. 3, an electronic module 202 may include a main board 202a. Main board 202a may be a standardized board common to other electronic modules 204-210 within the control system. Main board 202a may be a circuit board, motherboard, printed circuit board, or any other electronic board that includes the main board components described hereafter. Electronic module 202 may further include a network interface 300, a programmable controller 305, a configurable controller 310, a local data interface 315, one or more communication ports 320a, and 320b, a power supply circuitry 325, and memories 330a, 330b formed on main board 202a.

Power supply circuitry 325 generally provides appropriate power signals to different circuit elements within electronic module 202 such as, for example, network interface 300, programmable controller 305, memory 330a, 330b, configurable controller 310, etc. Various other known circuit elements may be associated with electronic module 202 and/or in communication with power supply circuitry 325, including gate driver circuitry, buffering circuitry, and other appropriate circuitry.

Network interface 300 may be configured to communicate with electronic module 202. Network interface 300 may be connected to both of programmable controller 305 and configurable controller 310. In one example, network interface 300 may be an Ethernet switch. However, other types of network or communication interfaces may suffice to operatively connect electronic module 202 to network 200. Additionally, in embodiments where network 200 includes different communication paths or sub networks, network interface 300 may be implemented with one or more interface circuits to accommodate the different format or different physical paths of network 200. For example, the interface circuits of network interface 300 may accommodate transmission of Ethernet TCP/IP based data, RS 232 data, RS422 data, CAN bus data via network 200. Although not shown in FIG. 3, electronic module 202 may further include one or more network ports, such as Ethernet ports, into which network cables may be plugged.

Configurable controller 310 contains internal circuitry that is configurable to implement control of machine 100. In other words, the internal circuitry of configurable controller 310 may be internally connected, disconnected, reconnected, and/or otherwise altered, in different configurations, to implement one or more control functions associated with the control of machine 100. In one embodiment, configurable controller 310 may work in conjunction with a field programmable gate array (FPGA), and may include programmable logic gates that may be reconfigured as desired. Configurable controller 310 may be configured to include a soft core processor such as the Nios processor included in Altera® FPGAs, or other like core processors. In some embodiments, a control application that is running on configurable controller 310 may require more sophistication and complexity than the configurable controller 310 is capable of providing. In this case, the control application may be implemented by both configurable controller 310 and the programmable controller 305. In such embodiments, the programmable controller 305 may have a higher processing capacity than configurable controller 310. Alternatively, in exemplary embodiments, the combined processing capacity of programmable controller 305 and configurable controller 310 may be sufficient to implement the desired control application regardless of the relative processing capacity of programmable controller 305 and configurable controller 310.

Configurable controller 310 may be connected to memory 330a, 330b. Memory 330a, 330b may be configured to store configuration files used by configurable controller 310 and/or programmable controller 305 to reconfigure the internal circuitry to perform certain functions related to the disclosed embodiments. In some embodiments, memory 330b may also store executable programs to be executed by the soft core processor in configurable controller 310. Memory 330b may include a volatile or non-volatile, magnetic, semiconductor, tape, optical, removable, non-removable, or other type of storage device or computer-readable medium. In some embodiments, configurable controller 310 may be configured to include a memory to store, for example, the configuration files used by configurable controller 310 and/or programmable controller 305.

Programmable controller 305 may be in communication with configurable controller 310 and network 200. Exemplary communication between configurable controller 310 and programmable controller 305 may be accomplished with a peripheral component interconnect express (PCIe) bus or other high speed data bus that facilitates quick and efficient communication between devices when implementing the control function. Alternatively, the communication between configurable controller 310 and programmable controller 305 may be accomplished through network 200. Additionally, programmable controller 305 may be in direct connection with the control element, such as a throttle actuator (not shown) or speed sensor (not shown). In exemplary embodiments, programmable controller 305 is adapted to provide computational support for a control function associated with electronic module 202. Computational support generally involves an offloaded task that may be accomplished with a processing unit, such as programmable controller 305. The control function, such as throttle control of the engine, may be one of a plurality of control functions associated with the control of machine 100.

Programmable controller 305 may be removably connected to main board 202a. The software of programmable controller 305 may be programmed to provide computational support to electronic module 202. For example, programmable controller 305 may provide support for various computational tasks, thus allowing for a more complex implementation of application than configurable controller 310. For example, programmable controller 305 may provide for asymmetric multiprocessing, mathematical processing, or other processing or co-processing functions known in the art. Programmable controller 305 may be a microcontroller, a microprocessor, a Computer-On-Module (COM), or a System-On-Module (SOM). For example, a SOM may have a processing capacity of 1-4 billion instructions per second. In one example, programmable controller 305 may be programmatically tasked with monitoring network 200 for messages. Programmable controller 305 may communicate with memory 330a formed on main board 202a of electronic module 202. Memory 330a may be used to store programs to be executed by programmable controller 305. Similar to memory 330b, memory 330a may include a volatile or non-volatile, magnetic, semiconductor, tape, optical, removable, non-removable, or other type of storage device or computer-readable medium. Alternatively, programmable controller 305 may communicate with other local peripheral devices not formed on main board 202a (e.g., control elements 230, 240, 242, 250 and 252) via a local data interface 315. Local data interface 315 may be implemented, for example, using a USB or SATA format.

In some embodiments, configurable controller 310 of electronic module 202 may communicate with one or more operatively connected devices via the one or more communication ports 320a and 320b. In such embodiments, via input and output (I/O) ports 360a-360c, configurable controller 310 of electronic module 202 may communicate with one or more control elements of other electronic modules 204-210 within the control system.

In some embodiments, one or more of I/O ports 360a, 360b, and 360c may be a CAN port that enables communication between electronic module 202 and other control elements that require CAN bus data. For example, an Electro Motive Diesel Engine Controller (EMDEC) which controls the locomotive engine may communicate with one or more elements via the CAN port. For example, an EMDEC may communicate via CAN transmission with network interface 300, programmable controller 305, configurable controller 310, etc. Since CAN data transmission may have relatively stringent timing requirements, exemplary embodiments may not require an interface controller to control data transmission.

Programmable controller 305 and configurable controller 310 may overlap in terms of their functions. That is, each one of programmable controller 305 and configurable controller 310 may independently interface with network 200 via network interface 300 to receive, process, initiate, and/or transmit messages. In addition, each one of programmable controller 305 and configurable controller 310 may have a processing capacity to host one or more control applications. However, programmable controller 305 may have a substantially large processing capacity, while configurable controller 310 may have relatively limited processing capacity. According to one embodiment, programmable controller 305 and/or configurable controller 310 may work either individually or in concert to host one or more control applications. Control applications may be stored on memory 330a, 330b, or another operatively connected non-transitory computer-readable medium.

### INDUSTRIAL APPLICABILITY

The disclosed control system and methods provide a robust and improved solution for protecting control elements during and after a control software termination. The disclosed systems and methods are able to mitigate or prevent damage to control elements due to a software process termination and restart caused by a software fault. Because the disclosed system and methods provide for an improved method of protecting machine control elements, a substantial reduction in technician time and machine down-time may be realized when a control system experiences an unexpected control software fault.

A software process may generally refer to an instance of a computer program that is being executed by one or more processors of electronic module 202, or another electronic module operatively connected to machine 100. For example, a process may be an instance of the control system processing the written instructions of control system software, at least in part. Depending on the operating system and the particular control system software, a process may be composed of multiple threads of execution that execute the written instructions of the control system software concurrently. A process may also be composed of a single thread of execution. A thread of execution is generally considered to be the smallest sequence of programmed instructions that may be independently managed by the operating system scheduler of a modern computing device. The written instructions may be processed by electronic module 202 on a programmable controller 205, configurable controller 310, and/or on any number of other processors operatively connected to electronic module 202. Those skilled in the art appreciate that a software process may take many forms, and may be executed by a wide array of computing methods and architectures.

Control system software may, at times, experience an error that causes the software and/or the control system to malfunction or enter into a failure condition. Generally, when an operating system running on electronic module 202 or another control system component detects a software error (for example, a “fault”), the operating system terminates the software process that has experienced the error. A common software error occurs when a program attempts to access a memory location that it is not allowed to access (a “memory access violation”). A fault may be also caused if the control system software issues a command to write to memory address “x,” when memory address “x” is a read-only memory address, or the program attempts to direct the processor to access a nonexistent memory address (a “segmentation fault”). In response to any of these phenomena, the operating system kernel (the central component of most operating systems) may then send a “stop” signal to the processor to terminate the process that caused the fault. The processor may then release some or all of the memory used by the program and terminate the process. Faults may also be caused due to external sources. For example, an external signal such as radar may cause a control element such as electronic module 202 to experience a fault. Those skilled in the art will understand that software faults may originate from many sources, both internal to machine 100 and external to machine 100.

If machine 100 is in operation when the control system terminates a process, the sudden or unexpected termination of the process may cause the control system to enter into a failure condition that may result in damage to system elements. An “expected” termination of a process may occur when the control system systematically terminates the control software processes in a sequence that prevents system damage. Depending on the architecture of the control system, an unexpected termination of a process may cause electronic module 202 to reset by powering down and then on again. Resetting control module 202 may terminate the control system software all at once, instead of terminating the software in a systematic order that safeguards control elements. The system may take several seconds or longer to reset the control system software. During the reset cycle, system equipment could be damaged from various physical phenomena on-board the machine.

For example, as the system is resetting, residual voltage in the machine components during the reset cycle could damage various system elements. The damage may be mitigated or avoided by shutting down control system software processes (hereafter called “process” or “processes”) in a particular order. In order to allow time for the systematic termination of the processes, the operating system may postpone the reset long enough to allow certain commands to be issued by the control system software. During the postponement, the control system may bring the machine to a safe state before the process is terminated and then reset.

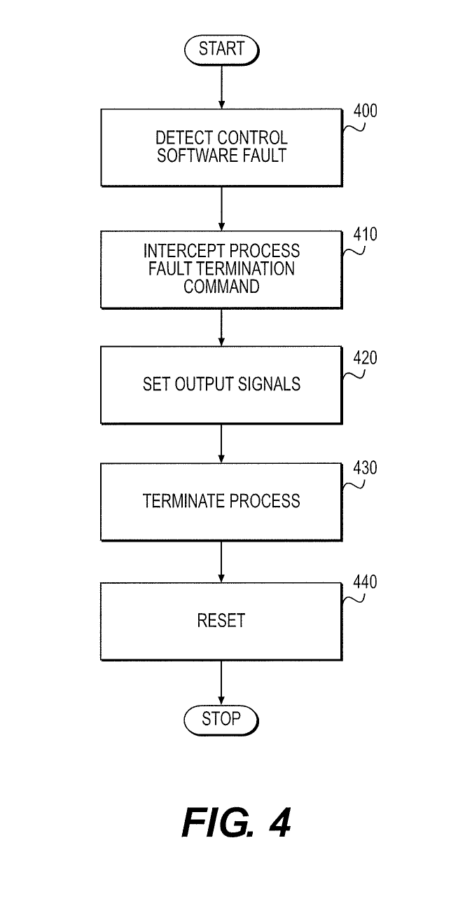

FIG. 4 illustrates a flowchart describing a process for protecting control elements of a machine. The first step in the process may be detection of a control software fault (Step 400). The software fault may be detected in a number of ways. For example, the software fault may be detected based on the behavior of the process, such as an unexpected and/or sudden termination of the process. The software fault may also be determined by a program or operatively connected device designed to monitor the control system for abnormal operating conditions such as a software fault. The software fault may also be detected by a hardware circuit as part of the control system. For example, as previously discussed, a watchdog circuit may monitor the control system for a failure condition caused by a control software error. One example of a hardware device designed to prevent hardware damage during a machine failure condition is the crowbar device previously described. A software fault may be detected by any part of the control system configured to perform such a task. For example, a software fault may be detected by a circuit on electronic module 202, and/or a software program running on electronic module 202. Detection of the control software fault may be accomplished by one or more components not specifically discussed herein, yet operatively connected to machine 100.

After the control system detects a control software fault, the control system may intercept the process fault termination command (Step 410). The process fault termination command that is intercepted by the control system may have been issued by the operating system running on electronic module 202, or some other control element of machine 100 as a response to detecting the error. It may be advantageous in some circumstances to direct the control system to delay the termination the software process until a predefined shut-down procedure is implemented. This delay may allow for other active processes to terminate in turn. Depending on the architecture of the control system and machine 100, machine components may be protected from damage by shutting down active processes in a particular order. An “active” process is a process that is in use by the control system at a particular time. A process fault termination command may be intercepted by one or more processors that may be configured to intercept a command. For example programmable controller 305 and/or configurable controller 310 may be configured to intercept the process fault termination command at Step 410.

Intercepting the process fault termination command may generally include postponing the command issued by an operating system, or any other control system software that directs electronic module 202 to terminate the one or more processes that have experienced a control software fault. In general, commands issued by an operating system to start and stop processes may be issued in “packets.” Those skilled in the art understand that when data is formatted into packets, the bit rate of the communication medium may be better shared among control elements such as, for example, electronic modules 202-210. Intercepting the process fault termination command may include detecting whether a particular packet has been issued by the operating system, and intercepting the packet. Accordingly, intercepting a process fault termination command may include retrieving the packet containing the process fault termination command. Intercepting the process fault may also include storing the packet in memory 330a and/or 330b until the output signals are set, and the faulty process is terminated. After the process fault termination command is intercepted, the command may be retained in memory 330a and/or 330b for a period of time to allow the control system to terminate the control software processes in turn.

Accordingly, the next step in the process of FIG. 4 is setting output signals (Step 420). The output signals set may cause the control system to terminate the necessary control system software processes in a predefined order. For example, in order to prevent the generator (not shown) from generating full-power during the reset cycle, electronic module 202 may set output signals that may direct machine 100 to power down in part according to a predetermined power-down procedure. Accordingly, the output signals may direct the generator to shut down all or part of its operation. In exemplary embodiments, such output signals may direct the generator to shut down such operations after turning off various other components of machine 100. According to one embodiment, setting output signals may include issuing one or more commands (computer instructions) that control software installed and operating on machine 100. Setting output signals may also include machine 100 performing the tasks associated with the particular output signals set. For example, a command may be issued to shut down a particular process on the electronic module responsible for control of the main power generator. In this case, setting the output signals also includes performing the instructions associated with the output signal set. For example, an output signal may include software-based instructions that direct the main power generator to power down, and setting such an output signal may include performing the corresponding step of powering down the main power generator.

According to one embodiment, the output signals set at Step 420 may include commands issued to both software elements and hardware elements. For example, the output signals may be set to shut down the generator by disabling one or more functions on a traction alternator control device onboard machine 100, and reboot the software running on the electronic module responsible for control of the generator. As another example, the output signals may include instructions for enabling or disabling various gates connected to the DC BUS of machine 100 (FIG. 1). Accordingly, the control system may set output signals by directing the generator controller to power down in a way that prevents damage to connected system elements. According to another embodiment, the output signals include instructions to delay a reset for a period of time. The reset delay may be a delay in resetting control system software, or other system software operating on machine 100. The reset delay may also be a delay in the resetting one or more hardware components of machine 100, such as a power generator or electronic module 202-210. For example, the output signal may issue instructions to the control system to delay a reset of electronic module 202 for a period of time spanning approximately 0.5 seconds to approximately 10 or more seconds. Output signals may be in any computer programming language suitable for control of the control system. According to another embodiment, the output signals may be set to control devices that are not shown, but may be on-board and operatively connected to machine 100.

Setting output signals at step 420 may also include a wide range of safe shut-down procedures. When output signals are set, the respective tasks associated with each output signal may be accomplished immediately after the signal is set, or may be accomplished at a later time, according to the written instructions of the output signal. For example, according to one embodiment, setting output signals 420 may include transmitting computer instructions that instruct a generator to shut down part of its generation immediately, and a second function of its generation process in 10 seconds. The output signals described above are exemplary only with respect to function of the output signal and number of output signals set. Accordingly, those skilled in the art will appreciate that the particular elements controlled, the number processes controlled, and/or the order of processes controlled by the output signals set may vary according to the architecture of the particular machine and control system.

After the output signals are set, the control system may terminate the process that has experienced a fault (Step 430). According to one embodiment, electronic module 202 may be reset (Step 440) by powering down and powering up again. According to another embodiment, only the process that has experienced the fault is reset at Step 440, while one or more active processes remain active. Resetting a process may include stopping the process, and restarting the process. Accordingly, electronic module 202 is continually powered on and not reset, but one or more processes running on electronic module 202 are reset.

The presently disclosed control system may have several advantages. Specifically, the presently disclosed control system may mitigate or avoid damage to machine components during a control system and/or control software reset. Avoiding damage to machine components may also avoid costly repairs to the machine, and costs associated with machine down-time.

It will be apparent to those skilled in the art that various modifications and variations can be made to the disclosed control system for a machine 100, such as a locomotive 120, and associated methods for operating the same. Other embodiments will be apparent to those skilled in the art from consideration of the specification and practice of disclosed control system. It is intended that the specification and examples be considered as exemplary only, with a true scope being indicated by the following claims and their equivalents.

What is claimed is:

1. A control system for a machine, comprising:
an electronic module, the electronic module comprising a memory storing a control system software; and
at least one programmable controller in communication with the memory, wherein the at least one programmable controller is configured to:
detect a control system software fault,
intercept a process fault termination command sent by an operating system in response to detecting the control system software fault,
set at least one output signal in response to detecting the control system software fault,
terminate at least one active control system software process associated with the control system software fault, and
reset at least part of the control system.

2. The control system of claim 1, wherein the at least one output signal includes instructions to terminate at least one active control system process.

3. The control system of claim 2, wherein the at least one active control system software process is terminated before the at least one active control software process associated with the control system software fault is terminated.

4. The control system of claim 3, wherein the control system software fault is caused by interference from a signal originating from a source external to the control system.

5. The control system of claim 1, wherein the control system software fault includes a memory access violation associated with an attempt by the electronic module to access memory that is not available for use by the control system.

6. The control system of claim 1, wherein the at least one output signal includes instructions to power down at least one control element according to a predetermined power-down procedure.

7. The control system of claim 1, wherein the at least part of the control system comprises the electronic module.

8. The control system of claim 1, further including a plurality of electronic modules, wherein the at least one output signal includes instructions to terminate a plurality of active processes running on at least one of the plurality of electronic modules, wherein the instructions direct the control system to terminate each of the plurality of active processes in a predetermined order.

9. The control system of claim 1, wherein the at least part of the control system includes a process running on the electronic module.

10. A method for controlling a machine comprising:
executing a control system software stored on an electronic module;
detecting a control system software fault;
setting at least one output signal in response to the control system software fault;
terminating at least one active control system software process associated with the control system software fault; and
resetting at least part of the control system.

11. The method of claim 10, wherein setting the at least one output signal includes setting instructions to terminate at least one active control system process.

12. The method of claim 10, wherein the at least one active control system software process is terminated before the at least one active control software process associated with the control system software fault.

13. The method of claim 10, wherein the control system software fault is caused by interference from a signal originating from a source external to the control system.

14. The method of claim 10, wherein the control system software fault includes a memory access violation associated with an attempt by the electronic module to access memory that is not available for use by the control system.

15. The method of claim 10, wherein the at least one output signal includes instructions to power down at least one control element according to a predetermined power-down procedure.

16. The method of claim 10, wherein the at least part of the control system comprises the electronic module.

17. The method of claim 10, wherein the instructions to power down include instructions to terminate a plurality of active processes running on at least one of a plurality of electronic modules, wherein the instructions direct the control system to terminate each of the plurality of active processes in a predetermined order.

18. The method of claim 10, wherein a plurality of active processes are terminated before the at least part of the control system software that contains the control system software fault is terminated.

19. The method of claim 10, wherein the setting at least one output signal includes instructions that causes at least one machine component to power down.

20. A control system for a machine, comprising:
a memory storing a control system software; and
an electronic module comprising at least one programmable controller in communication with the memory, wherein the at least one programmable controller is configured to:
detect a control system software fault,
intercept a process fault termination command,
set at least one output signal in response to the control system software fault, wherein the at least one output signal includes instructions that direct a control system to terminate a plurality of active processes in a predefined order;
terminate at least part of the control system software according to the instructions included in the at least one output signal; and
reset at least part of the control system.
